(19) United States
(12) Patent Application Publication
(10) Pub. No.: US 2004/0206845 A1
(43) Pub. Date: Oct. 21, 2004

(54) Device for enabling anglers to practice fishing technique and to exercise muscles used during fishing

(76) Inventor: Peter P. Aichinger, Redondo Beach, CA (US)

Correspondence Address: Irving Keschner, Suite 1150, 21515 Hawthorne Boulevard, Torrance, CA, 90503, US

(21) Appl. No.: 10/800,330

(22) Filed: Mar. 15, 2004

Related U.S. Application Data
(63) Continuation-in-part of application No. 10/177,326, filed on Jun. 24, 2002.

(51) Int. Cl. A01K 89/02

(52) U.S. Cl. 242/390.8

(57) ABSTRACT

A device which allows a customer to test fishing gear before purchasing the gear. The device comprises a housing having a variable speed motor and spool mounted within the enclosure. The outside of the enclosure has a guide which leads the fishing line to the spool, the line secured thereon. The motor torque is controllable and enables an angler to simulate the reeling in of a fish at a selected torque level; the angler, through the use of a remote control, simulates the running of a fish by winding the fishing line at a predetermined speed and torque level.

### RELATED APPLICATIONS

This is a continuation-in-part of application Ser. No. 10/177,326 filed Jun. 24, 2002.

### BACKGROUND OF THE INVENTION

1. Field of the Invention

The present invention provides a device for enabling fishermen to practice reeling in a fish against the spool brake.

2. Description of the Prior Art

The sport of fishing and the required equipment such as fishing rods and reels are well known and have been used for many years. Many fishing rods include apparatus for automatically winding and unwinding the fishing line from the fishing reel, the apparatus including a motor.

When a fish strikes the fish hook and attempts to escape, the angler, or fisherman, starts to reel in the fish and applies a braking force to the fishing line in order to reel in the fish without damaging the fishing rod and line. The caught fish is, at the same time, attempting to escape and as a result, applies a force to the fishing line.

U.S. Pat. No. 3,910,524 to Ireland and cited by the examiner during prosecution of the '326 application, is directed to a fishing downrigger assembly exclusively for use on a boat to raise and lower a weighted sinker attached to a fishing line so that the fising line lure can be maintained at a predetermined depth during trolling. The speed of the downrigger motor is relatively slow; in addition the downrigger assembly is not suitable for use in an outdoor environment wherein rain can short circuit the motor electrical components.

The ability to safely brake the line is dependent on the strength of the fish and the fishing gear utilized, particularly for deep sea fishing. It would thus be advantageous for fish tackle stores to have the capability of allowing customers to practice using fishing gear on land prior to a sale of merchandise or embarking on a fishing trip. In addition, fisherman tend to have extended periods of inactivity between fishing trips and thus the back and neck muscles that are utilized when reeling in a fish are little exercised, the muscles as a result becoming severely strained during the actual fishing trip.

What is thus desired is to provide a device that allows anglers to both practice using desired fishing gear and to exercise muscles used during fishing prior to embarking on the fishing trip.

### SUMMARY OF THE PRESENT INVENTION

The present device provides a device which allows anglers to practice using desired fishing gear while on land and also enables anglers to exercise the muscles used to reel in the fish. The device comprises a housing with a variable torque motor and spool contained therein. The outside of the housing has a guide which leads the fishing line to the spool, the line being secured thereon. The motor torque is controllable and enables an angler to simulate the reeling in of a fish at a selected torque level; the angler, through the use of a remote control, simulates the running of a fish by winding the fishing line at a predetermined and programmed speed and torque level.

The device also enables old fishing line to be unwound from reels, sharpen used treble hooks on lures using an inserted grinding stone, send damaged jigs for repainting and polish and clean eye-guides, knives and fishing reels. In addition, the device can be used to instruct children and beginning anglers prior to embarking on fishing trips; the device also aids in tackle shop sales by enabling customers to test new fishing gear prior to purchase.

### DESCRIPTION OF THE DRAWINGS

For a better understanding of the present invention as well as other objects and further features thereof, reference is made to the following description which is to be read in conjunction with the accompanying drawing wherein:

FIG. 1a is a perspective view of the device of the present invention;

FIG. 1b is a perspective view illustrating the remote control device;

FIG. 2a illustrates a spool spindle accessory;

FIG. 2b illustrates a disposable spindle accessory;

FIG. 2c illustrates a hook sharpener accessory;

FIG. 2d illustrates a brush accessory;

FIG. 2e illustrates a fishing guide line extension accessory;

FIG. 3 is a cross-sectional view along line 3-3 of FIG. 1;

FIG. 4 is a view along line 4-4 of FIG. 3;

FIG. 5 is a view of the slide and lock channel used to mount the device of FIG. 1 to concrete;

FIG. 6 illustrates in more detail the slide and lock channel of FIG. 5;

FIG. 7 illustrates the device of FIG. 1 with side channels for engagement with the slide and lock channel shown in FIGS. 5 and 6;

FIG. 8 is a simplified flow chart of the motor control software; and

FIG. 9 a simplified view illustrating an angler using the device of the present invention.

### DESCRIPTION OF THE INVENTION

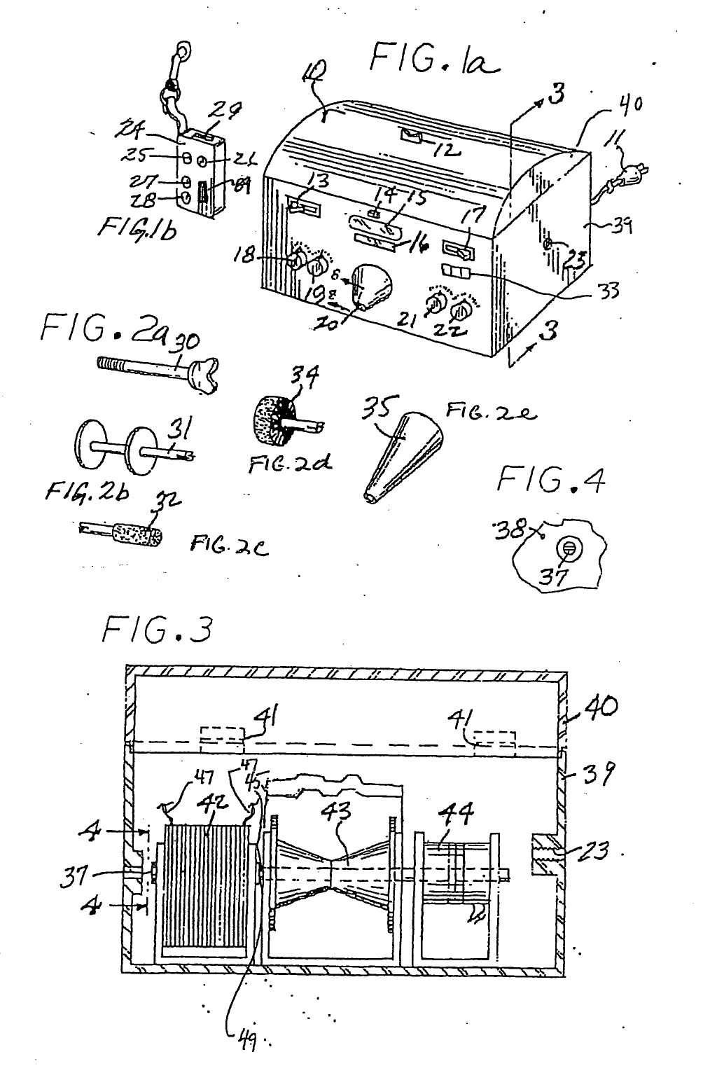

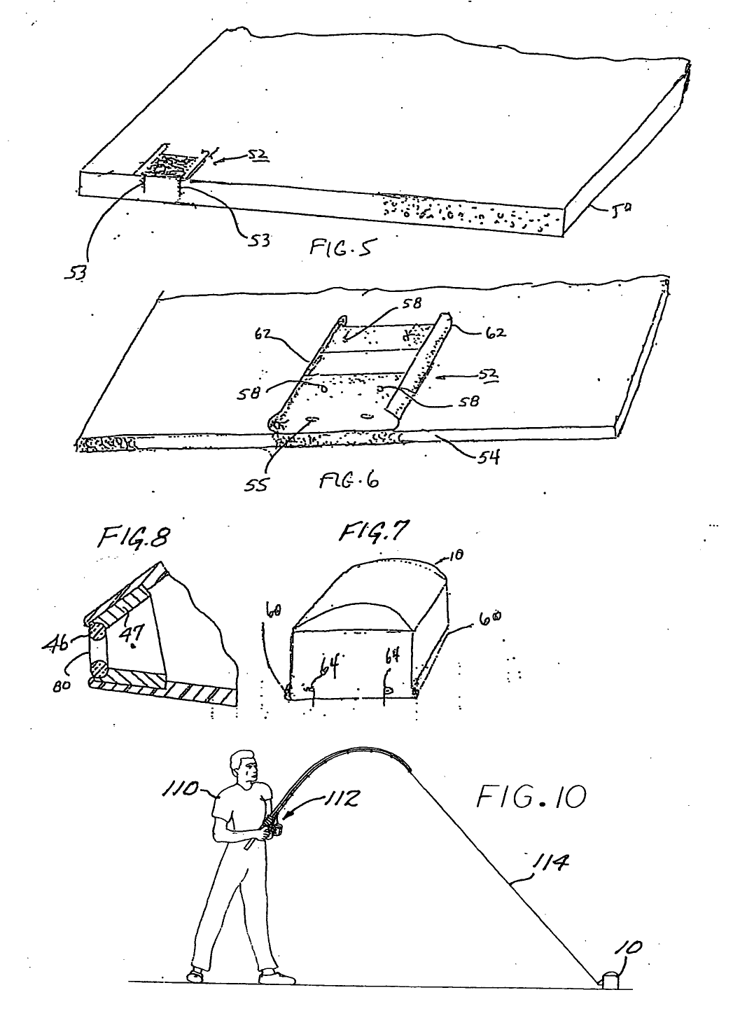

Referring now to FIG. 1, device 10 of the present invention is illustrated. Device 10 comprises a housing 39, preferably fabricated from extruded aluminum, having lid 40, an electric plug 11, fish line cutter 12, a motor energizing button 13, a button 14 to open lid 40, intensity meter 15, a remote control receiver window 16, on/off switch 17, variable speed control knob 18, fish line inlet guide 20, clutch resistance knob 21, intermittent line runs control knob 22 and spool spindle receiver 23. A remote control device 24 is provided which provides a technique for remotely controlling the operation of device 10. Device 24 comprises start reel windup button 26, power on/power off button 27 and sending window 29. Control 24 thus enables an angler to control the action of device 10 without having to bend to adjust the device parameters including button 27 for remotely turning on the device 10.

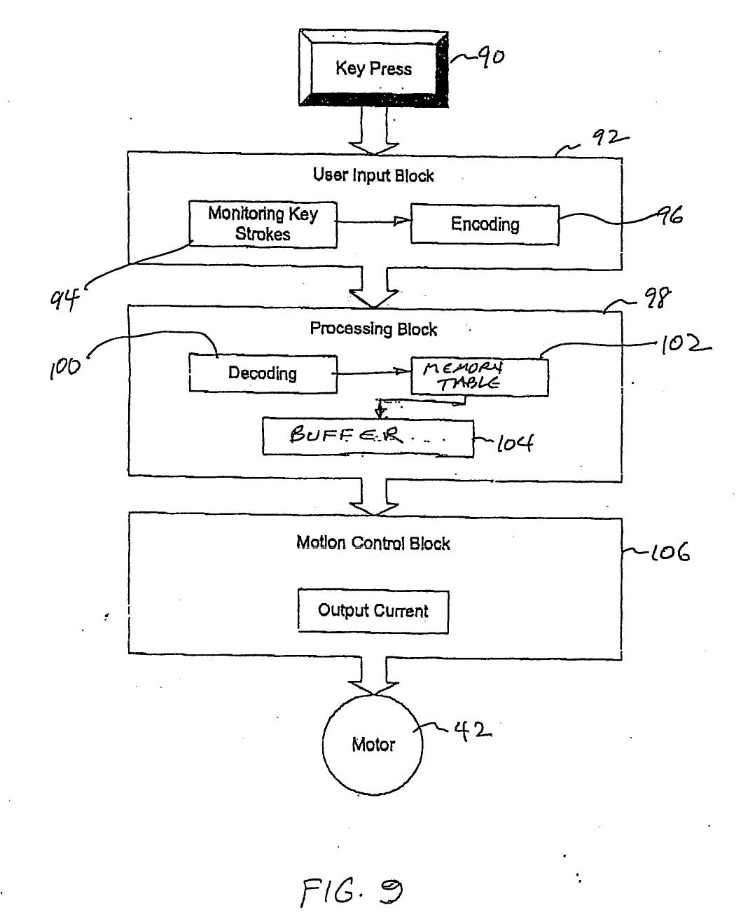

FIG. 2 illustrates the accessories for use with device 10 and includes new fish line spool spindle 30 for insertion into spindle receiver 23, disposable spindle 31 for old fish lines, hook sharpener 32, brush 34 and fishing line guide extension 35.

FIG. 3 is a cross-sectional view along line 3-3 of Figure illustrating the interior components of housing 39. The components comprise hinges 41, motor 42, reeling spool 43 and variable electric clutch 44. The accessories shown in FIG. 2 (other than spindle 30) are received in accessory drive 37. The output shaft 49 of motor 42 is coupled to reeling spool 43; when motor 42 is energized by a power source (not shown) via leads 47, shaft 49 causes spool 43 to rotate clockwise (thus reeling in the fishing line connected thereto) depending upon the characteristics of the voltage applied thereto.

FIG. 4 shows accessory drive 37 and recess 38 for pin 36.

FIG. 5 is a view illustrating how device 10 is secured to a concrete slab 50 on land using a slide and lock channel 52, slide and lock channels 52, preferably fabricated from extruded aluminum, being fastened to block 50 using concrete anchors 53. FIG. 6 illustrates the slide and lock channel 52 secured to plywood member 54 located on land using screws 55. A plurality of lock pin holes 58 are drilled through channel 52 into plywood member 54. FIG. 7 illustrates device 10 located on land and having rounded side channels 60 which slide into the groves 62 formed on lock channel 52. Lock pins 64 are inserted into holes (not shown) formed in the bottom of device 10 into the lock pin holes 58 formed in plywood member 54 to secure device 10 thereto.

FIG. 8 is a cross-sectional view along line 8-8 of FIG. 1 showing in more detail, snag proof fishline guide 20. In particular, glass eyelet 46 is positioned at the guide opening 80, heat resistant member 47 being positioned adjacent eyelid 46.

Referring now to FIG. 8, a simplified flow chart of the software which can be utilized to control motor 42 is illustrated.

An entry device, such as key press 90, is provided for the user who enters a particular code corresponding to the desired fish fighting characteristics. The output from key press 90 is coupled to user input block 92 comprising device 94 for monitoring the key strokes and encoding device 96. The output from block 92 is coupled to processing block 98 which decodes the encoded output via decoder 100; the output from decoder 100 is coupled to memory table 102 having stored data corresponding to the desired fish fighting characteristics. The output of memory 102 is coupled to output buffer 104, the output of buffer 104 being coupled to motor control block 106. Block 106 controls the amount of current supplied to motor 42 and thus the torque characteristics thereof.

A conventional microprocessor can be programmed to perform the tasks set forth in the above-described flow chart.

FIG. 10 illustrates angler 110 practicing with fishing gear 112, fishing line 114 being coupled to device 10 as illustrated.

In operation, a user introduces fishing line through inlet guide 20 and then ties the line about spool 43. Remote control 24 is used initially to couple the power source to motor 42, motor 42 in turn causing reeling spool 43 to reel in approximately 100 feet of fishing line. The motor is then shut off and the torque, or intensity, of the motor slip clutch and brake is then set. The motor is then turned on to a predetermined degree of torgue, thus causing the fishing line to tug, run and pull, simulating a fish running. In this regard, motor 42 is preferably provided with a microprocessor to determine the torque ranges and run and clutch characteristics. A knob on control panel 24 then enables a user to select the motor settings that correspond to the fighting characteristics of a particular sport fish being targeted in an upcoming fishing trip.

Housing 39 is provided with counter 33 to keep track of the fishing line furnished and then retrieved. The internal reeling spool 43 has a level wind 45 for evenly collecting the fishing line without buildup of line capacity on reeling spool 43.

The present invention thus provides a simple device that is located on land which allows an angler to practice his/her fishing technique prior to embarking on a fishing trip and also to exercise the muscles utilized when deep sea fishing. In addition, the device of the present invention enables tackle stores to provide a way for customers to try fishing tackle prior to purchase.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A device for enabling a user to practice fishing techniques using a rod having a fishing line comprising:
a housing;
a controllable motor positioned within said housing, said motor having an output shaft;
a reeling spool positioned within said housing and coupled to said motor output shaft;
means for attaching one end of said fishing line to said reeling spool;
means for supplying power to said motor; and
computer means coupled to said motor for adjusting the torque applied to said fishing line, said computer means enabling the user to choose a specific torque setting to simulate the fighting characteristics of a particular sport fish.

2. The device of claim 1 further including a counter for counting the length of the fishing line reeled and unreeled from said reeling spool.

3. The device of claim 2 further including means for preventing the line on said reeling spool from exceeding a predetermined capacity.

4. The device of claim 3 further including a fishing line inlet guide formed on said housing for receiving said fishing line.

5. The device of claim 4 further including means to remove fishing line from said rod.

6. The device of claim 5 further including means for enabling fishing lure hooks to be sharpened.

7. The device of claim 1 further including means to remotely enable power to be supplied to said motor.
